(19) United States
(12) Patent Application Publication
(10) Pub. No.: US 2011/0001961 A1
(43) Pub. Date: Jan. 6, 2011

(54) SECURITY OPTICAL FIBER SENSOR

(76) Inventor: Jorge Escuin Garcia, Begues (Barcelona) (ES)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/866,914

(22) PCT Filed: Feb. 20, 2009
(86) PCT No.: PCT/EP09/52049

§ 371 Date: Aug. 10, 2010

(30) Foreign Application Priority Data
Feb. 22, 2008 (EP) 08151834.2

(51) Int. Cl. G01J 1/10

(52) U.S. Cl. 356/229

(57) ABSTRACT

The invention relates to a security sensor (10) comprising a sensing device (21), a coming optical fiber element and a going optical fiber element, the sensing device (21) comprising a housing that receives a first end of the coming element and a first end of the going element. It is characterized in that the first end of the coming element and the first end of the going element in the housing are not aligned, and in that when a light beam enters the housing through the first end of the coming element, at least part of said light beam is reflected within the housing and exits through the first end of the going element.

The present invention relates to a security sensor. More specifically, the invention relates a security sensor comprising a sensing device, a coming optical fiber element and a going optical fiber element, the sensing device comprising a housing that receives a first end of the coming element and a first end of the going element.

The invention also relates to an extension device of said security sensor, a method for controlling the security sensor, a device for controlling the security sensor suitable for carrying out such a method, and a computer program for controlling the security sensor.

### BACKGROUND ART

A security sensor is an anti-theft device to prevent the theft or loss of any object exposed to the public, for example, in open access and free service, in shelves, exhibitors, etc. that for its high value are always most likely to disappear with the consequent and irreparable economic loss.

The U.S. Pat. No. 5,003,292 with title “Fiber optic security system for protecting equipment from tampering” describes a fiber optic security system for protecting expensive equipment from tampering or theft. The fiber optic security system comprises an emitter for generating signals, a detector connected to an alarm for monitoring the signals and a sensing coupler or photon switch that is easily mounted to each piece of equipment that requires protection without defacing the equipment. The sensing coupler mounts the tips of optical fiber ends in a position aligned along a single axis to allow light generated by the emitter to pass through. Any attempt to remove the sensing coupler causes the tips to be misaligned and the light to be deflected. This causes an optic path interrupt and causes the detector to trigger an alarm.

Said security system has a drawback in the arrangement of the optical fiber ends. Because the ends are aligned, any movement of the protected object can cause their misalignment and, consequently, the system generates an alarm due to an optic path interrupt. Therefore, said system only can be used in objects that are not moved or handled by the purchasers (for example, said system cannot be used in clothes, mp3/mp4 players, etc.).

### DISCLOSURE OF THE INVENTION

Therefore, an object of the invention is to provide a security sensor that can be used for protecting any type of object.

This object is achieved in accordance with claim 1 by providing a security sensor in which the first end of the coming element and the first end of the going element in the housing are not aligned, and in which when a light beam enters the housing through the first end of the coming element, at least part of said light beam is reflected within the housing and exits through the first end of the going element.

The provision of the arrangement of the ends of the optical fiber elements and the configuration of the housing allows the sensor protecting any type of object. The movement of the protected object causes no problem because light always enters in the housing through the coming element, reflects in the housing and exits through the going element. The security sensor only generates an alarm when at least one of the elements is cut or when anybody attempts to remove the sensing device from the protected object.

In one embodiment of the invention, the sensor further comprises means for connecting the sensor to a control device, said connection means being arranged at the second end of the coming element and the second end of the going element. The connection means may be a plug with a retainer.

In another embodiment, the sensing device comprises means for attaching the sensor to the object to be protected. For example, the attaching means may be a pad with a special adhesive.

Preferably, the housing comprises a hole, which is covered by the object to be protected when the sensor is attached to the object. The provided hole allows external light to enter in the housing when somebody attempts to remove the sensor from the protected object. This way, external light is detected by the control device and an alarm is triggered.

Alternatively, the hole may be a transparent portion of the housing. This way, the provided transparent portion allows external light to enter in the housing when somebody attempts to remove the sensor from the protected object.

Further, the sensing device may comprise a lighting signal, which may have the function of a beacon.

In one embodiment, the coming element and the going element are made of plastic optical fiber.

According to another aspect, the invention provides an extension device for a security sensor comprising a sensing device, a coming optical fiber element and a going optical fiber element, the sensing device comprising a housing that receives a first end of the coming element and a first end of the going element, means for aligning the first end of the coming element of the sensor and the second end of the coming element of the extension device, and means for aligning the first end of the going element of the sensor and the second end of the going element of the extension device, so that when a light beam enters the housing of the extension device through the first end of the coming element of the extension device, at least part of said light beam is reflected within the housing of the extension device and exits through the first end of the going element of the extension device.

This way, the protection can be extended to different parts of the object or the same security sensor can protect different objects.

According to yet another aspect of the invention, it is provided a device for controlling a security sensor comprising means for emitting a light beam through the coming optical fiber element, means for receiving the light beam through the going optical fiber element, means for determining an expected light beam, to be received by the receiving means, from the emitted light beam, means for verifying if the received light beam corresponds with the expected light beam, and means for triggering an alarm when the light beam received by the receiving means is not the expected one.

The control device, from the emitted light beam and the received light beam, determines if an alarm must be triggered:
If any or both of the optical fiber elements are cut, the verifying means determines that the received light beam (light is not received) is different from the expected light beam and triggers an alarm;
In case of anybody attempts to remove the security sensor from the protected object, external light enters in the housing through the hole of the housing, and said light is detected by the control device (the expected light beam is different from the received light beam, that is, the received light beam corresponds to the emitted light beam plus the external light). Obviously, in said case, the control device also triggers an alarm.

In another embodiment, the emitting means emits a pulsating light beam. This way, means for determining an expected light beam determines that the expected light beam is a pulsating one. In case of the received light beam is not a pulsating one, the control device triggers an alarm.

In one embodiment, the triggering means triggers an alarm when the light level of the light beam received by the receiving means is under a predetermined threshold (i.e. at least one optical fiber element has been cut).

On the other hand, the triggering means triggers an alarm when the light level of the light beam received by the receiving means is over a predetermined threshold (i.e. anybody has attempted to remove the security sensor from the protected object and light has entered in the housing).

The control device further may comprise means for receiving the connecting means of the security sensor.

In a preferred embodiment of the invention, a system for protecting an object comprises a security sensor and a device for controlling said security sensor, the connecting means of the security sensor being connected to the means for receiving the connecting means of the control device.

According to another aspect of the invention, it is provided a method for controlling a security sensor, comprising the steps of:
a. Emitting a light beam;
b. Receiving a light beam;
c. Determining an expected light beam from the emitted light beam;
d. Verifying if the received light beam corresponds with the expected light beam;
In case of negative result, executing the step of:
   e. Generating an alarm.

According to yet another aspect, the invention provides a computer program comprising program instructions for causing a computer to perform the method for storing multimedia files. Said computer program may be embodied on storing means (for example, on a record medium, on a computer memory or on a read-only memory) or carried on a carrier signal (for example, on an electrical or optical carrier signal).

### BRIEF DESCRIPTION OF THE DRAWINGS

In the following detailed description of some possible embodiments, other features and advantages of the invention will appear, each description being made with reference to the following drawings:

FIG. 1 is a schematic diagram illustrating the system for protecting an object, according to the invention;

FIG. 2 is a schematic diagram illustrating the security sensor of the system of FIG. 1, according to the invention;

FIG. 3 is a schematic diagram illustrating the optical fiber cable of the security sensor of FIG. 2;

FIG. 4 is a schematic diagram illustrating the housing of the sensing device of the security sensor of FIG. 2;

FIG. 5 is a flow chart illustrating the method for controlling the security sensor of FIG. 2, according to the invention.

### DETAILED DESCRIPTION

In the following detailed description, embodiments of a system for protecting an object according to the invention will be described. In said embodiments, the object is a multimedia player, which is exposed to the public, for example, in open access and free service, in an exhibitor.

Basically, as can be seen in FIG. 1, the system for protecting the multimedia player 11 comprises a security optical fiber sensor 10 and a device 12 for controlling said security sensor 10.

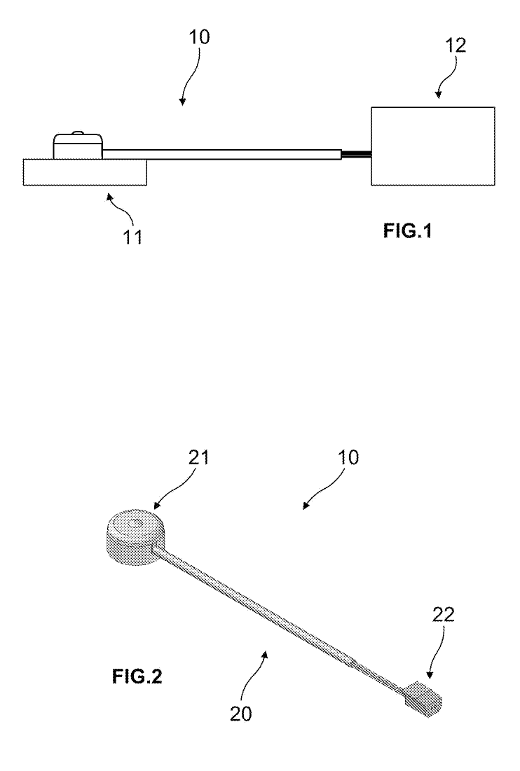

The security sensor 10 (see FIG. 2) comprises an optical fiber cable 20, a sensing device 21 arranged in a first end of the cable 20, and a connector 22 arranged in the second end of the cable 20.

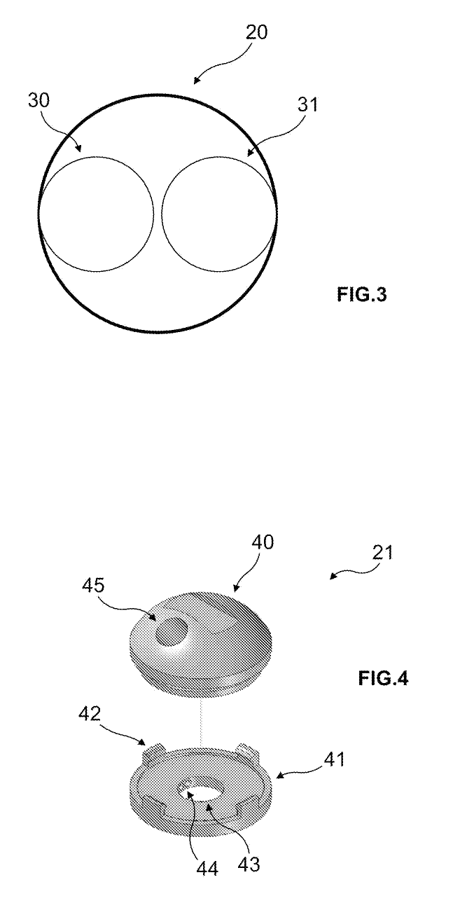

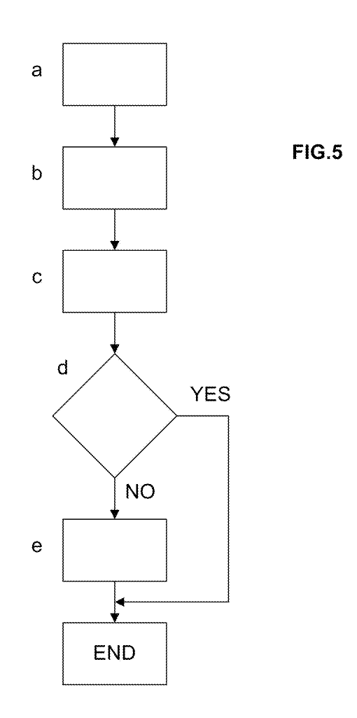

As can be seen in FIG. 3, the optical fiber cable 20 comprises a first optical fiber element 30 (hereinafter referred to as coming element) and a second optical fiber element 31 (hereinafter referred to as going element) and presents a coiled configuration. The cable 20 also comprises one flexible cover for each element 30,31, said covers being joined to form the single cable 20.

The coming and going elements 30,31 are made of plastic optical fiber and present polish ends. On the other hand, the elements have a diameter of approximately 1 mm.

The sensing device 21 comprises a housing. Said housing comprises a top lid 40 and a lower lid 41.

The lower lid 41 comprises flaps 42 for joining the top lid with the lower lid, a hole 43 through which light enters in the housing when the sensing device is being removed from the multimedia player 11, and two holes 44 for receiving a first end of the coming element 30 and a first end of the going element 31 respectively. The lower lid 41 also comprises a pad (not shown) for attaching the security sensor 10 to the multimedia player 11. Said pad comprises a suitable adhesive element for attaching the sensing device 21 to the multimedia player 11.

In a preferred embodiment of the invention, the first end of the coming element 30 and the first end of the going element 31 has to be a predetermined minimum distance from the reflective surface (the protected object surface or the housing surface) for achieving good results.

Alternatively, the hole 43 may be a transparent portion provided in the lower lid 41. This way, the provided transparent portion allows external light to enter in the housing when somebody attempts to remove the sensor from the multimedia player.

The top lid 40 comprises a transparent portion 45 that shows the light beam that arrives to the housing, obtaining the effect of a beacon (a lighting signal).

The connector 22 is a plug comprising a retainer for maintaining the connection between the security sensor 10 and the control device 12. The connector, For example, may be an HFBR-4516 Duplex Latching Connector.

The control device 12 comprises an element for receiving the connector 22 of the security sensor 10, a light emitter (e.g. a Light-Emitting Diode—LED) for emitting a light beam (e.g. a pulsating light beam), a light receiver (e.g. a light sensor) for receiving the emitted light beam, a computer program for controlling the security sensor 10, and a computer system on which the computer program is executed. Further, the control device 12 may comprise means for connecting the device to a computer network (e.g., a WiFi network) or to another computer system. This way, the data obtained by the control device 12 may be sent to the other computer system for their processing.

The computer program comprises a module for determining the expected light beam from the emitted light beam, a module for verifying if the received light beam is the expected light beam, and a module for triggering an alarm in case of the result in the verifying module is negative (that is, the received light beam does not correspond with the expected light beam).

It is possible to use an extension device of the security sensor 10 for extending the protection to other parts of the multimedia player 11 or for protecting more than one multimedia player (or another object). Said extension device comprises a sensing device, a coming optical fiber element and a going optical fiber element, the sensing device comprising a housing (with the same configuration than the housing of the sensing device 21 of the security sensor 10) that receives a first end of the coming element and a first end of the going element. Further, the extension device comprises means for aligning the first end of the coming element (30) of the sensor (10) and the second end of the coming element of the extension device, and means for aligning the first end of the going element (31) of the sensor (10) and the second end of the going element of the extension device, so that when a light beam enters the housing of the extension device through the first end of the coming element of the extension device, at least part of said light beam is reflected within the housing of the extension device and exits through the first end of the going element of the extension device.

The aligning means may be comprised in the housing, for example, in the lower lid of the housing.

FIG. 5 is a flow chart illustrating a preferred embodiment of a method for controlling a security sensor, according to the invention. Thus, beginning in a state in which the security sensor 10 is connected to the control device 12 by means of the connector 22 and the element for receiving said connector, the method for controlling the security sensor 10 comprises the following steps:
a. The light emitter emits a light beam (e.g. a pulsating light beam) through the coming element 30 (more specifically, through the second end of the coming element) of the security sensor 10;
b. The light receiver receives a light beam through the going element 31 (more specifically, through the second end of the going element) of the security sensor 10;
c. The determining module determines the expected light beam from the emitted light beam;
d. The verifying module verifies if the received light beam is the expected light beam;
In case of negative result, in a step (e), the triggering module triggers an alarm (e.g. an audible alarm and/or a visual alarm flashing the beacon).

Obviously, when the light emitter emits the light beam through the coming element 30, said light beam enters in the housing of the sensing device 21 through the first end of the coming element 30. Next, the light beam is reflected within the housing (the light beam is reflected on the housing surface and/or the protected object surface) and exits through the first end of the going element 31. The light beam exiting from the housing is the light beam received in the control device 12 (by the receiving means).

In case of light beam, within the housing, is reflected on the protected object surface, the control device 12 may comprise means for detecting the colour of the object surface and means for generating a light beam according to the detected colour.

Basically, it is possible to describe the verification of the received light beam in the control device 12 according to the following steps:
Verifying if the light level of the received light beam is under a first predetermined threshold (at least one of the elements 30,31 are cut);
In case of positive result, executing the step of:
   Generating an alarm;
In case of negative result, executing the steps of:
   Verifying if the light level of the received light beam is over a second predetermined threshold (the sensing device 21 is being removed from the protected object and external light enters in the housing);
In case of positive result, executing the step of:
   Generating an alarm.

On the other hand, if the emitted light beam is a pulsating light beam, it is possible to describe the verification of the received light beam in the control device 12 according to the following steps:
Verifying if the received light beam is a pulsating light beam;
In case of negative result, executing the step of:
   Generating an alarm.

If anybody cut at least one of the optical fiber elements, the receiving means do not receive the light beam (that is, the received light beam is not pulsating). If anybody attempts to remove the sensing device 21 from the multimedia player 11, light (obviously, not pulsating) enters in the housing and exits from it through the first end of the going element. Consequently, the received light beam is not pulsating.

Thus, while the preferred embodiments of the security sensor, the extension device, the control device, the system for protecting and object and the method for controlling the sensor device have been described in reference to the environment in which they were developed, they are merely illustrative of the principles of the invention. Other embodiments and configurations may be devised without departing from the scope of the appended claims.

Further, although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code intermediate source and object code such as in partially compiled form, or in any other form suitable for use in the implementation of the processes according to the invention. The carrier may be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal, which may be conveyed via electrical or optical cable or by radio or other means.

When the program is embodied in a signal that may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

1. A security sensor (10) comprising a sensing device (21), a coming optical fiber element (30) and a going optical fiber element (31), the sensing device (21) comprising a housing (40,41) that receives a first end of the coming element (30) and a first end of the going element (31), characterized in that the first end of the coming element (30) and the first end of the going element (31) in the housing (40,41) are not aligned, and in that when a light beam enters the housing through the first end of the coming element, at least part of said light beam is reflected within the housing and exits through the first end of the going element.

2. A sensor according to claim 1, further comprising means (22) for connecting the sensor (10) to a control device (12), said connection means being arranged at the second end of the coming element (30) and the second end of the going element (31).

3. A sensor according to claim 1, wherein the sensing device (21) comprises means for attaching the sensor to the object (11) to be protected.

4. A sensor according to claim 3, wherein the housing (40,41) comprises a hole (43), which is covered by the object (11) to be protected when the sensor (10) is attached to the object.

5. A sensor according to claim 1, wherein the sensing device (21) comprises a lighting signal (45).

6. A sensor according to claim 1, wherein the coming element (30) and the going element (31) are made of plastic optical fiber.

7. An extension device for a security sensor (10) according to claim 1, characterized in that it comprises a sensing device, a coming optical fiber element and a going optical fiber element, the sensing device comprising a housing that receives a first end of the coming element and a first end of the going element, means for aligning the first end of the coming element (30) of the sensor (10) and the second end of the coming element of the extension device, and means for aligning the first end of the going element (31) of the sensor (10) and the second end of the going element of the extension device, and in that when a light beam enters the housing of the extension device through the first end of the coming element of the extension device, at least part of said light beam is reflected within the housing of the extension device and exits through the first end of the going element of the extension device.

8. A device (12) for controlling a security sensor (10) according to claim 1, characterized in that it comprises means for emitting a light beam through the coming optical fiber element (30), means for receiving the light beam through the going optical fiber element (31), means for determining an expected light beam, to be received by the receiving means, from the emitted light beam, means for verifying if the received light beam corresponds with the expected light beam, and means for triggering an alarm when the light beam received by the receiving means is not the expected one.

9. A control device (12) according to claim 8, wherein the emitting means emits a pulsating light beam.

10. A control device (12) according to claim 9, wherein the triggering means triggers an alarm when the light beam received by the receiving means is not a pulsating light beam.

11. A control device (12) according to claim 8, wherein the triggering means triggers an alarm when the light level of the light beam received by the receiving means is under a predetermined threshold.

12. A control device (12) according to claim 8, wherein the triggering means triggers an alarm when the light level of the light beam received by the receiving means is over a predetermined threshold.

13. A control device (12) according to claim 8, further comprising means for receiving the connecting means (22) of the security sensor (10).

14. A system for protecting an object (11) comprising a security sensor (10) according to claim 1 including a control device (12) having a connecting means (22) and a security sensor (10), the connecting means (22) of the security sensor (10) being connected to means for receiving the connecting means of the control device (12).

15. A method for controlling a security sensor (10) according to claim 1, comprising the steps of:
a. Emitting a light beam;
b. Receiving a light beam;
c. Determining an expected light beam from the emitted light beam;
d. Verifying if the received light beam corresponds with the expected light beam;
In case of negative result, executing the step of:
e. Generating an alarm.

16. A computer program comprising program instructions for causing a computer to perform the method for controlling a security sensor (10) according to claim 15.

17. A computer program according to claim 16, embodied on storing means.

18. A computer program according to claim 16, carried on a carrier signal.
